(19) United States
(12) Patent Application Publication
(10) Pub. No.: US 2006/0101448 A1
(43) Pub. Date: May 11, 2006

(54) Printing device

(76) Inventor: Gregory Alan Shue, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/970,478

(22) Filed: Oct. 21, 2004

(51) Int. Cl. G06F 9/44

(52) U.S. Cl. 717/168; 717/136

(57) ABSTRACT

A printing device can create a first image of control firmware in a volatile storage area. The printing device can transform the first image so as to create a second image in the volatile storage area, where the second image is an image of a second version of the control firmware.

### BACKGROUND

A printing device may store control firmware in a read-only memory (ROM), such as a masked ROM for example. Sometimes firmware in a printing device may need to be updated in order to provide the printing device with added functionality or to remedy an unwanted feature of the firmware. One prior way of upgrading printing device firmware stored in a ROM is to replace the ROM with a new ROM that stores the upgraded firmware.

Replacing an existing ROM in a printing device with a ROM that stores upgraded firmware is often inconvenient and time consuming. Furthermore, production of the ROM itself may entail large up front costs and long turn around times. For example, production of a masked ROM that stores upgraded firmware can involve large up-front costs for tooling. Additionally, production of the tooling may take a significant amount of time.

### BRIEF DESCRIPTION OF THE DRAWINGS

FIG. 1 shows a high-level block diagram of a printing device;

FIG. 2 shows a timeline illustrating graphically when each of three different firmware versions is released by a manufacturer;

FIG. 3A shows a firmware image that is initially created after a first version of control firmware is loaded into a RAM;

FIG. 3B shows a firmware image that is initially created when a second version of control firmware is loaded into a RAM;

FIG. 3C shows a firmware image that is initially created when a third version of control firmware is loaded into a RAM;

FIG. 4 shows some of the contents of the printing device memory;

FIGS. 5A and 5B show a flow chart that illustrates an aspect of the printing device operations during a particular boot cycle;

FIG. 6 shows a computing system that includes the printing device; and

FIG. 7 shows a flowchart for illustrating an example of how a host computer, a server computer and the printing device may operate in the computing system.

### DESCRIPTION

As used herein, the phrase “printing device” refers to any device that includes a printing function. Thus, for example, the phrase “printing device” may refer to an inkjet printer, a laser printer, a commercial printing press, a multifunction peripheral (MFP) that includes a printing function, etc.

Printing Device Construction

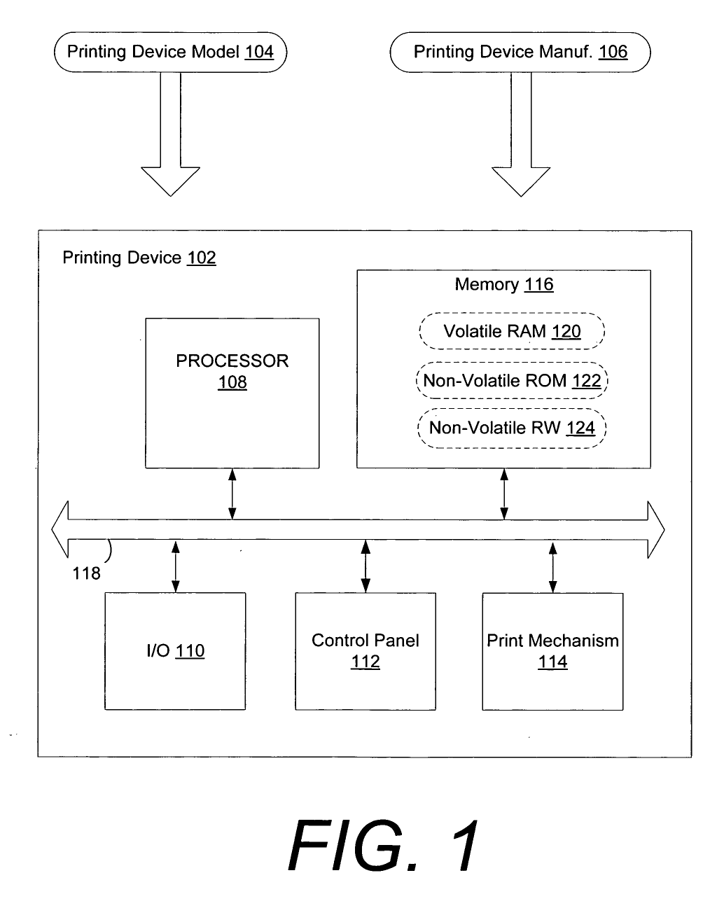

Shown in FIG. 1 is a high-level block diagram of a printing device 102 that is accordance with one example embodiment of the invention. We will assume in the following discussion that the printing device 102 is representative of one of a particular model of printing device (printing device model 104) that is manufactured and sold by a particular manufacturer (printing device manufacturer 106).

The printing device 102 may include, for example, a processor 108, an input/output (I/O) port 110, a local control panel 112, a print mechanism 114, and a memory 116. The printing device 102 further includes a local bus system 118 that interconnects aspects of these elements. For example, the local bus system 118 may include data, control and address lines that interconnect the processor 108 with aspects of the memory 116.

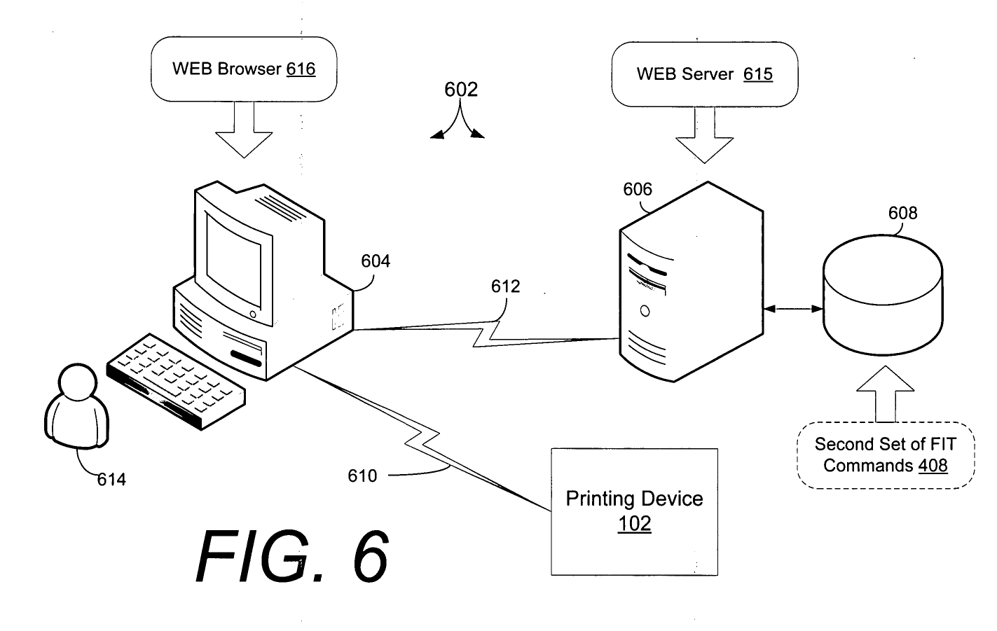

The I/O port 110 generally enables the printing device 102 to receive and transmit signals over a communication link. In some implementations, the I/O port 110 may enable the printing device 102 to receive a print job from a host computer (such as the host computer shown in FIG. 6) over a wired or a wireless communication link.

The local control panel 112 provides a user interface to the printing device 102 and may include one or more displays for displaying information and user selectable options. Additionally, the local control panel 112 may further include one or more mechanisms (e.g., user input keys, touch pad, a mouse, etc) for allowing a user to provide input.

The print mechanism 114 generally includes various components that enable the printing device 102 to produce printed output. In some implementations, for example, the print mechanism 114 may comprise an inkjet print mechanism, for example. In these implementations, the print mechanism 114 may include one or more inkjet print heads for ejecting ink onto a print media. In other implementations the print mechanism 114 may comprise a laser print engine that implements an electro-photographic (EP) process to produce printed output.

The printing device memory 116 includes different types of storages areas. These storage areas include, in this example embodiment, a volatile random access memory (RAM) 120, a non-volatile read-only memory (ROM) 122 and a non-volatile read-writable memory (RW memory) 124. The ROM 122 may comprise a masked ROM, for example. The RW memory 124 may comprise a read-writable flash memory, for example.

The processor 108 generally controls the operation of the printing device 102 by executing, from the RAM 120, an image of control firmware. As is discussed in greater detail below, the processor 108 loads an image of control firmware into the RAM 120 each time the printing device 102 is booted.

Control Firmware Development

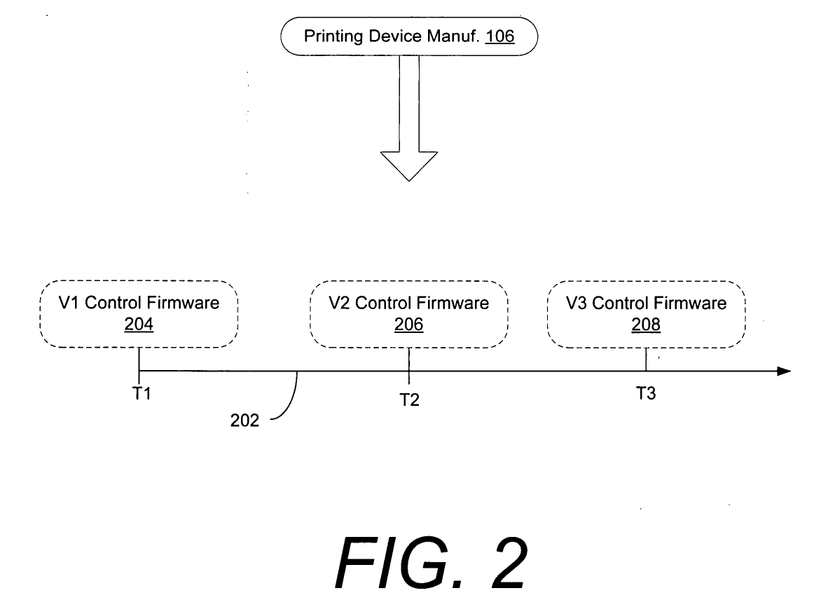

For illustration purposes, we will assume a hypothetical scenario wherein three versions of control firmware have been developed for the printing device model 104 over a particular period of time. Shown in FIG. 2 is a timeline 202 illustrating graphically when each of these three firmware versions is released for use in the printing device model 104 by the printing device manufacturer 106.

With reference to the timeline 202, a first version of control firmware (V1 control firmware 204) is released for use in the printing device model 104 at time “T1”. Time “T1” may correspond to when the printing device model 104 was first released for sale into the marketplace, for example.

At time “T2” a second version of control firmware (V2 control firmware 206) is released for use in the printing device model 104. The V2 control firmware 206 is intended by the manufacturer 106 to be an improvement over the V1 control firmware 204.

At time “T3”, a third version of control firmware (V3 control firmware 208) is released for use in the printing device model 104. The “V3” control firmware 208 is intended by the manufacturer 106 to be an improvement over the V2 control firmware 206.

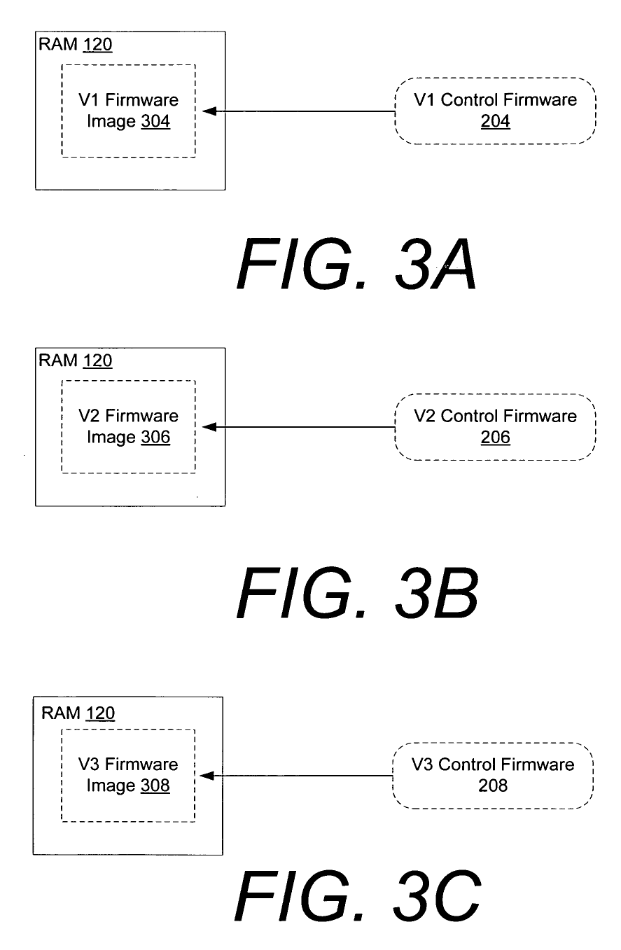

As previously noted, the processor 108 generally controls the operation of the printing device 102 by executing an image of control firmware from the RAM 120. For the later discussion, FIG. 3A shows the firmware image (V1 firmware image 304) that is initially created after the V1 control firmware 204 is loaded into the RAM 120. Thus, the V1 firmware image 304 represents the state of the RAM 120 after the V1 control firmware 204 has been fully loaded into the RAM 120 but prior to the processor 108 executing the firmware from the RAM 120.

Likewise, FIG. 3B shows the firmware image (V2 firmware image 306) that is initially created when the V2 control firmware 206 is loaded into the RAM 120. FIG. 3C shows the firmware image (V3 firmware image 308) that is initially created when the V3 control firmware image 208 is loaded into the RAM 120.

Contents of Printing Device Memory

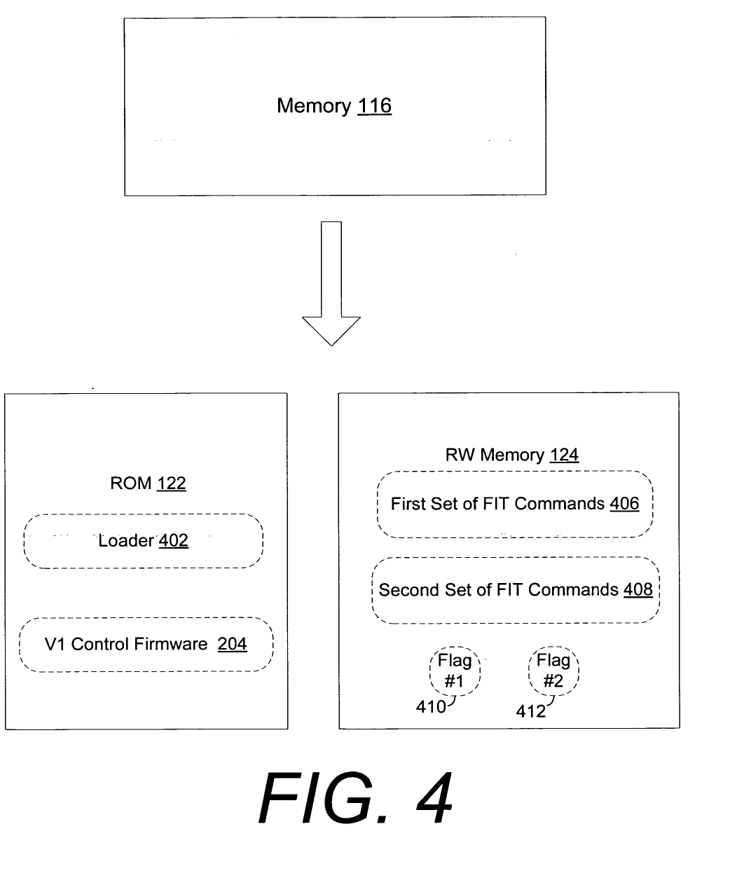

FIG. 4 illustrates some of the data that is stored in the printing device memory 116. As shown in FIG. 4, the ROM 122 stores a firmware loader 402 and the V1 control firmware 204. The RW memory 124 stores a first and a second set of “firmware image transform” (FIT) commands 406, 408. Also stored in the RW memory 124 is a first and a second control flag 410, 412.

Generally speaking, the first set of FIT commands 406 can be executed by the processor 108 to transform the V1 firmware image 304 into the V2 firmware image 306. The second set of FIT commands 408 can be executed by the processor 108 to transform the V2 firmware image 306 into the V3 firmware image 308. The use of these commands and the two control flags are described further below.

It is noted that the memory 116 may store additional data that is not shown in FIG. 4. For example, the memory 116 may store other control flags in either volatile or non-volatile memory.

Printing Device Boot Operation

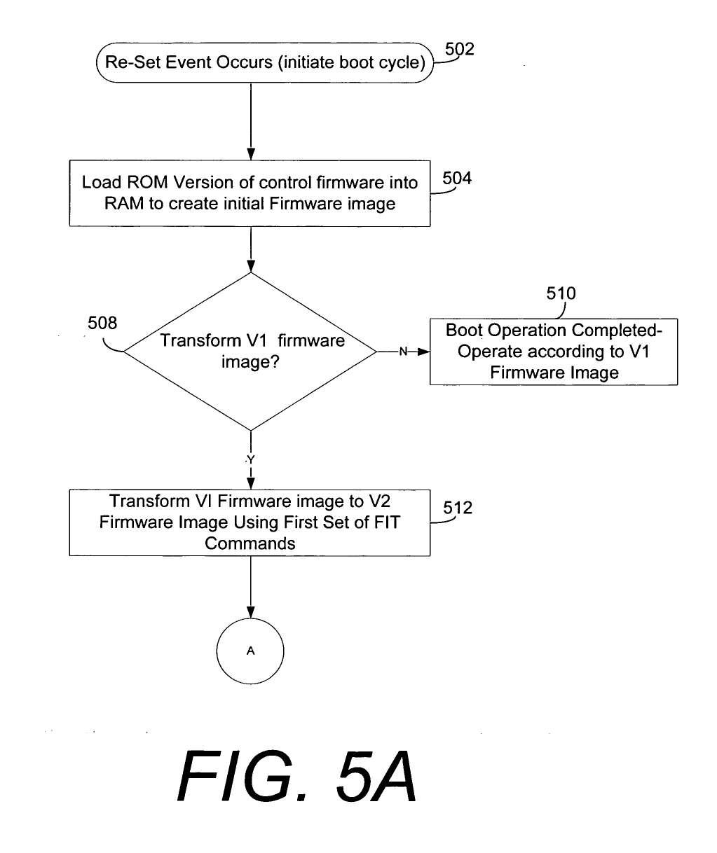

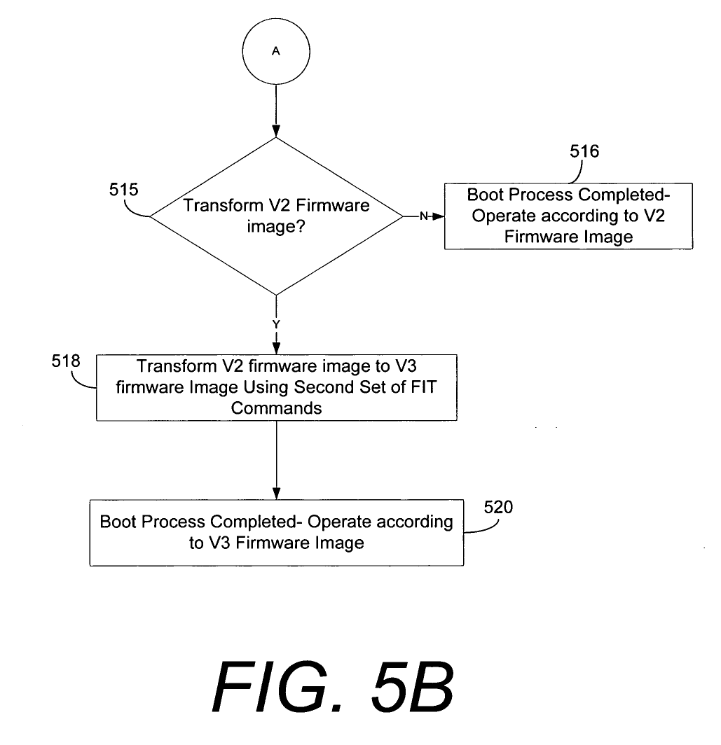

Shown in FIGS. 5A and 5B is a flow chart that illustrates an aspect of the printing device 102 operation to load an image of control firmware into the RAM 120 when the printing device is booted.

Beginning at step 502, the printing device 102 experiences a re-set event. This event may be a re-set signal being applied to the processor 108, for example. In some cases, such a signal may be applied to the processor 108 when the power to the printing device 102 is turned from OFF to ON or when a user selects a re-set option at the local control panel 112, for example. Such a signal may also be applied to the processor 108 when power is turned from ON to OFF and/or when the printing device 102 is plugged into a power outlet, for example.

In response to the re-set event, the processor 108 begins executing the loader 402 so as to boot the printing device 102. The operation of the processor 108 to boot the printing device 102 is described below with reference to steps 504-520.

At step 504, the processor 108 loads an image of the firmware that is presently stored in the ROM 122 into the RAM 120. Thus, in this example, the processor 108 loads the V1 control firmware 204 into the RAM 120 thereby creating the V1 firmware image 304.

At step 508, the processor 108 decides whether to transform the firmware image created at step 504. This decision may be based on any number of factors. In the present embodiment, for example, the decision whether to transform the firmware image is based upon the present setting of the first control flag 410.

If the first control flag 410 is not set, for example, then the processor 108 decides not to transform the V1 firmware image 304 and the boot operation ends (step 510). After the boot operation ends, the processor 108 begins executing the V1 firmware image 304 so as to control the operation of the printing device 102. Thus the printing device 102 would proceed to operate in accordance with the first version of the control firmware at least until the printing device 102 is booted again.

If, however, the first control flag 410 is set, then the processor 108 performs step 512. At step 512, the first set of FIT commands 406 are executed by the processor 108 so as to transform the V1 firmware image 304 (presently loaded in the RAM 120) into the V2 firmware image 306.

After the V2 firmware image 306 is created in the RAM 120, the processor 108 then decides whether to transform this image into the V3 firmware image 308 (step 515). This decision may also be based on any number of factors. In the present embodiment, for example, the decision whether to transform the V2 firmware image 306 is based upon the present setting of the second control flag 412.

If the second control flag 412 is not set, for example, then the processor 108 decides not to transform the V2 firmware image 306 and the boot operation ends (step 516). After the boot operation ends, the processor 108 then begins executing the V2 firmware image 306 from the RAM 120 so as to control the operation of the printing device 102. Thus, the printing device 102 would proceeds to operate in accordance with the second version of the control firmware at least until the printing device 102 is booted again.

If, however, the second control flag 412 is set, then the processor 108 continues to step 518. At step 518, the second set of FIT commands 408 are executed by the processor 108 so as to transform the V2 firmware image 306 into the V3 firmware image 308.

At step 520, the boot operation ends and the processor 108 begins executing the V3 firmware image 308 from the RAM 120 so as to control the operation of the printing device 102. Thus, the printing device 102 would proceed to operate in accordance with the third version of the control firmware at least until the printing device 102 is booted again.

Setting of Control Flags

As described above, in the present embodiment, the decision to transform the V1 firmware image 304 is based on the setting of the first control flag 410 and the decision to transform the V2 firmware image 306 is based upon the setting of the second control flag 412.

It is noted that these flags may be set (or unset) in any number of ways. In some implementations, for example, one or both of these flags may be independently set (or unset) by the manufacturer 106, automatically by the printing device itself, or by an end user.

For example, in the present embodiment, a user may interact with the control panel 112 to set (or unset) the first or the second control flag 410, 412 prior to the printing device 102 performing the boot operation just described. In this respect, the user can control which of the three firmware versions will be executed by the printing device 102 after the boot operation is completed. This feature may be useful in a number of situations.

For example, the user may decide that he/she is not happy with the way the printing device 102 operates when booted to the V3 control firmware 208. In this situation, the user may interact with the control panel 112 to set the first control flag and unset the second control flag 412. The user may then re-boot the printing device 102 by, for example, power cycling the printing device 102. Because the first control flag 410 is set and the second control flag 412 is not set when the printing device 102 reboots, the printing device 102 would reboot to the V2 control firmware 206.

Storage Requirements of Firmware Image Transform (FIT) Commands

It is noted that the storage capacity needed to store a set of commands for transforming a firmware image in RAM from one version to another can be relatively small. This may in part be due to certain similarities that exist between the two firmware images.

For example, the V1 firmware image 304 described above may include blocks of data that do not change when the V1 firmware image 304 is transformed to the V2 firmware image 306. In such cases, the first set of FIT commands 406 need not include significant information related to these common blocks of data as they are not affected by the transformation operation.

Additionally, the V1 firmware image 304 may include blocks of data that are identical to blocks of data in the V2 firmware image 306 but at different RAM address locations. For example, suppose the V1 firmware image 304 includes a block of data (block A) at RAM address location “A”. Suppose further that the V2 firmware image 306 includes an identical block of data at RAM address location “B” and at RAM address location “C”. Under this scenario, the first set of FIT commands 406 may include a command that directs the processor 104 to move block “A” in the V1 firmware image 304 to address location “B” and to address location “C” so as to build the V2 firmware image 306. Note though that this command need not describe the contents of block “A”. The data size, therefore, of this command can be relatively small as compared to the data size of block “A” for example.

In the present embodiment, for example, the total storage capacity needed to store both the first set of FIT commands 406 and the second set of FIT commands 408 is significantly less than if the RW memory 124 was used to store either the V1,V2 or V3 control firmware 204, 206 208. Accordingly, it can be seen that the overall storage capacity of the RW memory 124 can be significantly less as compared to the storage capacity of the ROM 122, for example. Thus, in some embodiments, the RW memory 124 may represent a relatively small storage capacity memory component.

Performing Firmware Updates Prior to and after Product Shipment

It is noted that updating the control firmware in the printing device 102 can be accomplished in the present embodiment without having to replace the ROM 122 as the information needed to perform the update (i.e., the FIT commands) can be electronically written to the RW memory 124.

With reference to FIG. 2, suppose the printing device 102 is shipped after time “T2” but before “T3”. The manufacture 106 may update the V1 control firmware 204 prior to the printing device 102 being shipped to a customer by electronically writing the first set of FIT commands 406 into the RW memory 124 and by setting the first control flag 410. The ability of the manufacture 106 to update the firmware in this manner can be advantageous as the manufacture 106 need not acquire a replacement for the ROM 122 that stores the V2 control firmware 206.

Also, the printing device 102 may be updated to the V3 control firmware 208 sometime after time “T3” by, for example, a user of the printing device 102. In this respect, the manufacturer 106 may deliver the second set of FIT commands 408 to the user in some manner and the user may then interact with the printing device (or a host computer connected to the printing device) to store the second set of FIT commands 408 in the RW memory 124 and to set the second control flag 412. Thus the user is able to update the firmware in the printing device 102 after the printing device has been shipped by the manufacturer 106 without having to replace the ROM 122.

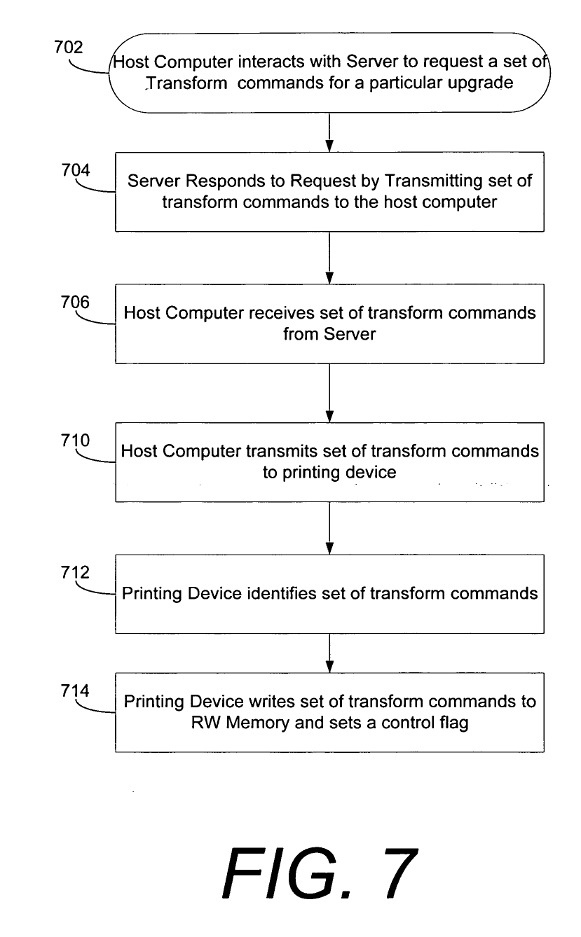

To illustrate one example of how the manufacturer may deliver a set of FIT commands to a user, attention is directed to FIG. 6 and FIG. 7. Shown in FIG. 6 is a computing system 602 that includes the printing device 102, a host computer 604 and a server computer 606 that has access to a database 608. The database 608 may include, for example, a record of the second set of FIT commands 408.

We will assume that a user 614 operates the host computer 604 and that the host computer 604 can communicate with the printing device 102 via a first communication link 610. The communication link 610 may be a wired or a wireless communication path (e.g., a local intranet, a communication cable, etc), for example.

The host computer can also access the server computer 606 via a second communication link 612. The second communication link 612 may be the Public Internet, for example. It is further noted that the server computer 606 may run a Web Server 615 and the host computer may run a Web Browser 616.

FIG. 7 shows a flowchart for illustrating an example of how the host computer 604 may, at the direction of the user 614, interact with both the server computer 606 and the printing device 102 to configure the printing device 102 with the second set of FIT commands 408.

With reference to FIG. 7, we assume the host computer 604 interacts (at the direction of the user 614) with the server 606 to identify and request the second set of FIT commands 408 (step 702). This interaction may involve the Web Server 615 causing the host computer 604 to display various user interfaces (such as Web pages) on the host computer 604 that allow the user to search the database 608 for the second set of FIT commands 408.

In response to the request received at step 702, the server computer 606 operates to transmit a package of commands (that include the second set of FIT commands 408) that is in accordance with a pre-determined protocol to the host computer 604 (step 704). In some implementations, the pre-determined protocol may be the same protocol used to electronically communicate a print job to the printing device 102.

At step 706, the host computer 604 receives the package from the server computer 606. At step 708, the host computer 604 transmits the package to the printing device 102.

At step 710, the printing device 102 receives the package and responds to it by performing step 712 and step 714. At step 712, the printing device parses the package to identify the second set of FIT commands 408. At step 714, the printing device 102 operates to write the V2 the second set of FIT commands 408 to the RW memory 124 and sets, if necessary, the first control flag 410 and also sets the second control flag 412. The user 614 may then reboot the printing device (e.g., by power cycling the printing device 102, for example) to cause the printing device to begin executing the third version of firmware.

It is further noted that the present invention may be embodied in the form of a “computer-readable medium”. As used herein, the phrase “computer readable medium” can refer to any medium that can contain, store or propagate computer executable instructions. Thus, in this document, the phrase “computer-readable medium” may refer to a medium such as an optical storage device (e.g., a CD ROM) or a magnetic storage device (e.g., a magnetic tape). The phrase “computer-readable medium” may also refer to signals that are used to propagate the computer executable instructions over a network or a network system, such as the Public Internet.

Thus, a memory component (e.g., the memory 116) that stores computer executable instructions (e.g., the loader 402 or a set of FIT commands) may represent an embodiment of the invention. Furthermore, signals used to propagate the firmware over a communication link (e.g. an intranet, Public Internet, etc) may also represent an embodiment of the invention.

Although several specific embodiments of the invention have been described and illustrated, the invention is not to be limited to specific forms or arrangements of parts so described and illustrated.

For example, the printing device 102 may include more or less than two sets of FIT transform commands. According to one embodiment, for example, the printing device 102 is configured with “N” different sets of FIT commands allowing the printing device to selectively boot to “N” different versions of control firmware. The value of “N” may be any whole number. According to another embodiment, for example, the printing device 102 is capable of updating its own control firmware by interacting directly with the server 615 to retrieve a set of FIT commands. The printing device 102 may be configured to take this action periodically or at the request of a user, for example.

Accordingly, the invention is limited only by the claims and the equivalents thereof.

1. In a printing device that includes a non-volatile storage area and a volatile storage area, where the non-volatile storage area stores a first version of control firmware, a method comprising:
booting the printing device; and
wherein the booting act includes:
creating a first image of the control firmware in the volatile storage area;
deciding whether to transform the first image; and
if the decision is to transform the first image, then transforming the first image so as to create a second image in the volatile storage area, where the second image is an image of a second version of the control firmware.

2. The method of claim 1, further comprising:
after the booting act is completed, executing a firmware image presently stored in the volatile storage area so as to control the operation of the printing device.

3. The method of claim 1, further comprising:
after the booting act is completed, executing a firmware image presently stored in the volatile storage area so as to control the operation of the printing device at least until the next time the printing device performs the booting act.

4. The method of claim 3, wherein the non-volatile storage area is a masked Read-Only Memory.

5. The method of claim 3, wherein the transforming act includes:
moving a block of data in the first image from one address location to another address location in the volatile storage area.

6. The method of claim 1, wherein the booting act further includes:
reading a set of commands from the non-volatile read-writable storage area;
executing, by a processor in the printing device, the commands to perform the transforming act, where at least one command directs the processor to move a block of data in the first image from one address location to another address location in the volatile storage area.

7. The method of claim 1, wherein the booting act further includes:
if the first image is transformed into a second image, then deciding whether to transform the second image;
if the decision is to transform the second image, then transforming the second image into a third image, where the third image is an image of a third version of the control firmware.

8. The method of claim 7, further comprising:
after the booting act is completed, executing the firmware image that is presently stored in the volatile storage area.

9. The method of claim 8, further comprising:
wherein the decision to transform the first image is based upon a present setting of a first control flag and the decision to transform the second image is based upon a second control flag; and
wherein at least one of the first and the second control flag can be set or unset by a user.

10. A method of booting a printing device, comprising:
loading a first version of control firmware in a random access memory (RAM) so as to create an initial firmware image; and
transforming the initial firmware image into a second firmware image, wherein the second firmware image is an image of a second version of the control firmware.

11. The method of claim 10, further comprising:
prior to loading the first version of the control firmware into the RAM, reading the first version of control firmware from a Read Only Memory (ROM).

12. The method of claim 10,
reading a set of commands from non-volatile read-writable storage area; and
executing, by a processor in the printing device, the commands to perform the transforming act, where at least one command directs the processor to move a block of data in the initial firmware image from one address location to another address location in the RAM.

13. The method of claim 12, wherein the non-volatile read-writable storage area is flash memory.

14. The method of claim 10, wherein the loading and transforming act are all performed during a single boot cycle.

15. The method of claim 10, further comprising:
deciding whether to transform the second firmware image;
if the decision is to transform the second firmware image, then transforming the second firmware image into a third firmware image; and
wherein the third firmware image is an image of a third version of the control firmware.

16. The method of claim 15, wherein the decision whether to transform the second firmware image is based upon a present setting of a control flag and wherein the control flag can be set or unset by a user.

17. A printing device, comprising:
a random access memory (RAM);
a processor; and
a read-writable memory that stores a first set of commands for causing the processor, during a boot cycle, to transform an image of a first version of control firmware after being loaded in the RAM into a second image, where the second image is an image of a second version of the control firmware.

18. The printing device of claim 17, wherein the printing device further includes a ROM that stores the first version of control firmware.

19. The printing device of claim 17, wherein the printing device does not store the second version of the control firmware.

20. The printing device of claim 18, wherein the printing device does not store the second version of the control firmware.

21. The printing device of claim 18, wherein the ROM further includes a loader program, where the loader program directs the processor during a boot operation to load the first version of control firmware into the RAM.

22. A printing device, comprising:
a read-only memory (ROM) that stores a first version of control firmware;
a random access memory (RAM); and
means for booting the printing device, at least in part, by:
creating, in the RAM, a first image of the first version of the control firmware; and
transforming the first image created in the RAM into a second image, where the second image is an image of a second version of the control firmware.

23. The printing device of claim 22, further comprising:
means for executing an image of control firmware in the RAM after the booting means has booted the printing device;
means for printing a page; and
wherein the page printing means operates under the control of the executing means.

24. In a server computer, a method comprising:
receiving a request for a set of commands;
responding to the request by transmitting the set of commands; and
wherein the set of commands can be used by a printing device to transform, during a boot cycle, a first firmware image loaded into a random access memory into a second firmware image, where the first firmware image is an image of a first version of control firmware and the second firmware image is an image of a second version of control firmware.

25. The method of claim 24, wherein the request is received from a host computer connected to the printing device.

26. The method of claim 24, wherein the request is received from the printing device.

27. The method of 24, wherein the server transmits the set of commands using a same protocol used to transmit print jobs to the printing device.

28. A method of upgrading control firmware in a printing device comprising random access memory (RAM), comprising:
transmitting, by a host computer, a set of commands to the printing device;
wherein the set of commands enable the printing device to, during a boot cycle, transform a first firmware image of a first version of control firmware loaded into the RAM into a second firmware image of a second version of control firmware.

29. The method of claim 28, further comprising:
receiving, by the printing device, the set of commands;
writing, by the printing device, the set of commands into a read-writable memory.

30. A method of upgrading control firmware in a printing device comprising random access memory (RAM), comprising:
receiving, by the printing device, a set of commands from a server;
writing, by the printing device, the set of commands into a read-writable memory; and
wherein the set of commands enable the printing device to, during a boot cycle, transform a first firmware image of a first version of control firmware loaded into the RAM into a second firmware image of a second version of control firmware.

31. One or more computer-readable media containing computer-executable instructions that, when executed by a printing device processor, cause the processor to:
transform a first image of a first version of control firmware presently stored in a random access memory (RAM) into an image of a second version of the control firmware.

32. The computer readable media of claim 31, wherein the image is transformed while the printing device is performing a boot operation.
